(19) United States
(12) Patent Application Publication
(10) Pub. No.: US 2022/0010535 A1
(43) Pub. Date: Jan. 13, 2022

(54) Siphon Drive Shower

(71) Applicants: Benjamin Martin Haneckow, Kalamazoo, MI (US); Lindsey Rene Haneckow, Kalamazoo, MI (US)

(72) Inventors: Benjamin Martin Haneckow, Kalamazoo, MI (US); Lindsey Rene Haneckow, Kalamazoo, MI (US)

(21) Appl. No.: 17/300,473

(22) Filed: Jul. 12, 2021

Related U.S. Application Data
(60) Provisional application No. 63/102,946, filed on Jul. 10, 2020.

(51) Int. Cl. E03C 1/04; A47K 3/38; A61H 33/00

(52) U.S. Cl. CPC E03C 1/0408; A47K 3/38; A61H 2201/105; A61H 33/6042; A61H 2201/5007; A61H 33/6068

(57) ABSTRACT

Thermo therapy method, device providing user of method, patient using method, an intermittent, actuation, cycle, of a water supply pipe, water source, medium source water in relation, juxtapose with means to adjust conditions, dimensions of start point, temperature, volume, location, time, repetitions, pressure, ambient temperature, relating to an experience, a prescription. Thermo therapy can actuate, cycle, dump with a siphon driven apparatus. A siphon drive shower. Which can be purpose built. Can be retro fit with plumbing, fixture, supply, drain. Can be new use of existing item; including a shower curtain rod. Producing any feature quality activity found useful including and not limited to immune system booster, pre vaccine preparation, post vaccine recovery, side effect minimization, vaccine booster, virus mitigation, therapeutic modality, weight management, exercise modality, stress management; manual operations of stretching, breathwork, meditation, Yoga, Tai Chi. Additionally the electronic exchange, communication, recording of information user, patient find useful.

Background Field of Invention problems prior art don't discuss advantages knock prior

Thermodynamic therapy. thermo therapy, has been used in a variety of methods, forms. Ice baths, cold showers, saunas, whirlpool hot tubs, ice packs. hot packs and others.

A general problem of prior art is that the activity of methods is usually an uncomfortable experience. An unpleasant experience. This can have a negative effect on a user starting thermo therapy and on a user continuing thermo therapy. Prior art can leave person using thermo therapy unable to adjust the conditions of thermotherapy. Prior art can require a specifically designed item, machine, other space encompassing to be purchased. Prior art can operate at regular pressure of plumbing supply system.

Prior art tends to prescribe set defined conditions relating to thermo therapy. A first condition Start point can be the step of beginning therapy session, jumping in a ice bath or stepping into a cold shower can have uncomfortable unpleasant enactment of start point.

A second condition is temperature of medium. The temperature of the water in cold shower, or the temperature of the water in an Ice bath, or the temperature inside a sauna all contain a fear factor affecting a person before and during thermo therapy can have uncomfortable unpleasant enactment.

A third condition is volume of medium. When a user approaches a therapy method and sees the tub full of ice and water or hear a shower head running, with high water flow a mental feeling related to the amount of medium, the volume of medium they are to-be exposed to can be a detractive force

A fourth condition is location of medium contact upon a person's body. Thermo therapy can be exclusionary to some persons based on personal preference or medical background related to how much exposure they must endure with thermo therapy, related to where upon their person they must be in contact with thermo therapy.

A. fifth condition is time of therapy. All Thermo therapy has a time element. A person may have an impatience relating to this requirement, may wish to receive a different time of therapy that prior art require.

A Sixth condition is repetitions of therapy. In some cases, no repetitions are allowed without cost increase. Some prior art only prescribes one repetition per session. In some cases, a person may not have control over repetitions of therapy based on how they feel for that day or availability.

A seventh condition is pressure of medium. Cold water is difficult enough to interact with but when it is at a set high pressure can discourage use.

Additionally, prior art can be expensive and cumbersome, could require a person to drive to a clinic or dedicate a space within their residence to equipment. Conditions of prior art require the people using it to overcome with high levels of mental psych mental motivation

Present invention offers ability for user to adjust start point by adjusting flow rate thru a shower head water supply pipe, a water source, or a medium source of water. Present invention can offer user ability to adjust temperature with control of a thermostatic control valve, a shower valve, any other temperature changing control valve. Additionally as water, a water source, or medium source of water all can change temperature towards ambient temperature a low flow rate can adjust temperature. Volume of shower head water supply, a water source, medium source of water can all be adjusted by adjusting a valve throttling flow rate, the size of siphon in terms of cross sectional profile can change volume. Location of water dump on user, location of user in relation to siphon, position juxtapose to siphon all can be adjusted by user manually moving themselves to preferred location around siphon or user can position siphon into different location producing different point of contact. Time of siphon dump, actuation, cycle can each be adjusted with a combination of volume of reservoir and size of siphon. Repetitions of invention can be adjusted by user of course with user choosing number of repetitions to perform. Repetitions of invention are also related to level of other adjustments, if a user has a baseline number of repetitions and they wish to perform a higher number of repetitions they can adjust a corresponding temperature or other adjust available, repetitions can be measured in dumps, actuations, cycles per unit of time in this measure repetitions can be changed with volume and pressure. Pressure can be adjusted with the height of developed siphon. If a siphon outlet measured to siphon inlet is changed the pressure at outlet will change. Additionally pressure of water into reservoir may contribute to pressure of siphon during dump actuation, cycle. Ambient temperature can be adjusted by changing temperature of air around user. Though not directly adjusted by invention the contribution of ambient air upon user during use of invention can relate to controlling ambient air temperature.

### SUMMARY

Present method can provide a thermo therapy device relating to the conditions of start of therapy, temperature of medium used in therapy, location on person of thermo therapy volume of medium used in therapy, time of therapy, repetitions of therapy and pressure of medium used in therapy, ambient temperature used in therapy. Method can use a siphon device to deliver a thermo therapy medium to a user. Method can be a shower rod to hold shower curtain. Method can be a flexible barrier support to hold a flexible barrier. Method can record results of conditions

### DRAWINGS DESCRIBED, ONE SHORT SENTENCE FOR EACH FIGURE

FIG. 1 is a overview of components of method

FIG. 2 is a side view of method

FIG. 3 is a isometric view of method

FIG. 4 is a side view of method.

FIG. 5 is a isometric view of method.

FIG. 6 is a isometric view of method.

FIG. 7 is a isometric view of method.

FIG. 8 is isometric view of method.

FIG. 9 is a isometric view of method.

FIG. 10 is a isometric view of method.

FIG. 11 is a side view of method.

FIG. 12 is isometric view of method.

FIG. 13 is a isometric view of method.

FIG. 14 is a isometric view of method.

FIG. 15 is a isometric view of shower curtain rod

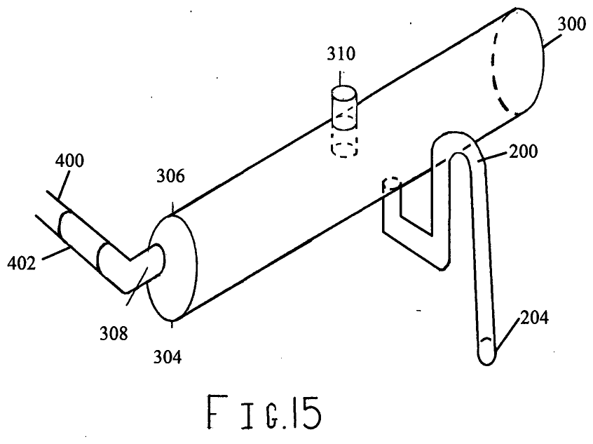

FIG. 16 a flowchart of software

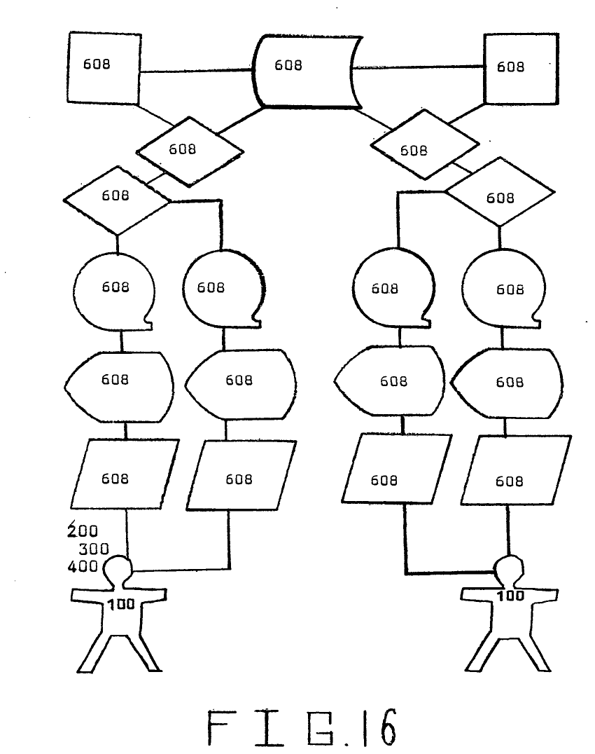

### DRAWING LIST REFERENCE NUMBERS

100 person.
200 siphon.
202 siphon inlet
204 siphon outlet.
206 siphon apex.
208 siphon weir.
210 siphon crown.
212 siphon centerline.
214 siphon delivery.
216 siphon dip.
300 reservoir.
302 reservoir centerline.
304 reservoir bottom.
306 reservoir top.
308 reservoir supply,
400 medium supply.
402 medium valve.
500 fill port.
502 shower sprayer.
504 hose to shower valve.
506 means to drain.
508 fill port flood plane.
600 shower curtain.
602 flexible barrier.
604 shower curtain ring.
606 flexible barrier ring.
608 appurtenance.
10000 siphon actuated shower.
5210 siphon crown reference.
5304 reservoir bottom reference.

A first embodiment of present invention can be a siphon curtain rod can be constructed with any construction useful

### DESCRIPTION AND OPERATION OF ALTERNATIVE EMBODIMENTS

Embodiment of invention can be constructed with materials components hardware showerhead water supply pipe, can fill rod reservoir with water until it dumps thru siphon in relation to user the water can enter drain, providing useful experience to user

The siphon curtain rod can operate in conjunction with shower curtain hooks.

Embodiment of invention can be constructed with materials components hardware water source can fill reservoir water source can fill siphon siphon can actuate the water filled from water source towards a location allowing user to position in relation to siphon, drain can redirect the water user can benefit from method in any way found useful.

Embodiment of invention siphon curtain rod can be built with copper, cpvc, galvanized, pex, stainless steel, any other material. Can be a new use for an existing article. Can be built so as to hold a shower curtain and provide use full experience to user.

Embodiment of invention siphon actuated shower can be built with copper, cpvc, galvanized, pex, stainless steel any other material with useful qualities

Embodiment of invention method for siphonic cycle thermo therapy device can be constructed with any means to enact method including but not limited to, copper, cpvc, galvanized, pex, stainless steel any other material with useful qualities, any hardware or fasteners or supports

a connection to a shower head water supply pipe can be any direct or indirect connection to rod reservoir.

Connection to shower head water supply pipe can be a indirect connection whereas a shower sprayer can be positioned with rod reservoir so as it can fill rod reservoir.

Connection to shower head water supply can be any connection between shower head water supply pipe to rod reservoir, including and not limited to, threaded, soldered, crimped, flared.

Connection to shower head water supply can be constructed with material including and not limited to, pipe, tube, hose,

a water source can be including and not limited to, city water supply pipe, a well, a rain reclamation tank, a hot water, a clod water, a water heater, a geothermal, a solar, a mixing valve, any other useful water source. A shower valve, a faucet, a sink,

medium source of water can be including and not limited to, city water supply pipe, a well, a rain reclamation tank, a hot water, a clod water, a water heater, a geothermal, a solar, a mixing valve, any other useful water source. A purpose built for invention plumbing water supply

The water source can be an existing plumbing fixture water supply.

The water source of claim 1 further including said water source can be a purpose built water supply

The medium source of water can include medicinal additives which can include and not be limited to medicine, aroma therapy oils substances, electrolytes, anti oxidants, resonant frequency additions, salts, soaps,

Siphon can be any device commonly understood to transport a liquid with gravity.

Siphon can receive additional movement potential with pressure of water supply, water source, and can be constructed in a fashion that flow is intermittingly interrupted.

Siphon can be built with a siphon dip a plurality of high points and low points of siphon whereas filling this causes a plurality of siphons to output random results, random cycle, random actuation, random dump.

Siphon can be built with plurality of siphons.

Siphon can be built with a scheduled cycle, actuation, dump whereas filling causes plurality of siphons to work in a more scheduled pattern. plurality of siphons to output scheduled results, scheduled cycle, scheduled actuation, scheduled dump.

Siphon can have a mechanical component affixed which effect random or scheduled cycle, actuation, dumps.

Siphon can dump, actuate, cycle with a plurality of users. Siphon can branch off so as to dump, actuate, cycle plurality of users synchronously. A plurality of users can use a plurality of siphons.

Rod reservoir can be device with ability quality to receive water for siphon to use.

Rod reservoir can have a vent, rod reservoir can have a air chamber or inverted bucket type air chamber, can have a air bladder.

Rod reservoir can support a shower curtain.

Rod reservoir can be constructed with shower curtain hooks that are built around components of invention. That are built around the shape of rod reservoir.

Rod reservoir can be wall mounted. Rod reservoir can be ceiling mounted. Can be positioned around the periphery of a shower or bathtub or other fixture.

Rod reservoir can be constructed for use with existing shower or bathtub or other fixture.

Rod reservoir can be purpose built for a bathroom remodel or a hotel construction, a building project.

Rod reservoir can have a valve that control flow from water supply, water source.

Rod reservoir can have a shot entry construction allowing addition of medicinal additives.

Rod reservoir can be used in plurality.

Rod reservoir can have a control valve

Rod reservoir can be device with ability quality to receive water for siphon to use.

Rod reservoir can have a vent, rod reservoir can have a air chamber or inverted bucket type air chamber, can have a air bladder.

Rod reservoir can support a shower curtain.

reservoir can be wall mounted. Rod reservoir can be ceiling mounted. Can be positioned around the periphery of a shower or bathtub or other fixture.

reservoir can be constructed for use with existing shower or bathtub or other fixture.

reservoir can be purpose built for a bathroom remodel or a hotel construction, a building project.

reservoir can have a valve that control flow from water supply, water source.

reservoir can have a shot entry construction allowing addition of medicinal additives.

reservoir can be used in plurality.

reservoir can have a control valve

reservoir can have a vent, rod reservoir can have a air chamber or inverted bucket type air chamber, can have a air bladder.

The reservoir of claim 1 further including said reservoir can be constructed with means to be purpose built.

A user can be a human. User can be a group. User can be class.

User can be a dog, user can be a cat, user can be a pet.

Patient can be a human. Patient can be a group. Patient can be a class patient can be a dog, user can be a cat, user can be a pet.

Drain can be a existing plumbing drain, drain can be a shower drain, drain can be a floor drain,

Drain can connect to a building drain, building sewer, a city sewer, a dry well, a drain field, a septic tank. Drain can be piped to a waste water treatment. Drain can be piped to a tank.

drain can be constructed with means to be purpose built plumbing fixture drain.

The drain can have a device to measure. Drain can measure temperature. Drain can have test port. Drain can test for medical markers, viruses.

showerhead water supply pipe, can fill rod reservoir with water until it dumps thru siphon in relation to user the water can enter drain, providing anything useful.

water supply can fill reservoir water supply can fill siphon siphon can actuate the water filled from water source towards a location allowing user to position in relation to siphon drain can redirect the water user can benefit from method in any way found useful. medium source of water can energize reservoir medium source of water can energize siphon medium source of water can then cycle thru siphon towards a location allowing user to position juxtapose to siphon in any way found useful drain can process medium water useful can be a immune system booster, a vaccine booster, a therapeutic modality, a weight management modality, a exercise modality. Useful can be used for vaccine booster. Useful Cn be covid mitigation.

manual operation program can be a program designed to produce routines for using invention. Manual operation can choreograph site specific routine of invention. Manual operation can include thermo therapy upon arms, legs, back, chest, neck, lower back, head knees, shoulders. Hands, feet

Useful can be a software device capable of recording processing electronic information related to invention and displaying information to user upon a electronic device.

Useful can be a software device capable of recording processing electronic information related to invention and displaying information upon a electronic device. Sent by a user.

The siphon actuated shower means to adjust start point. This can be any any device including and not limited to, a gate valve, a ball valve, a globe valve, a thermometer, a flow indicator, a control valve, a timer, camera. A microphone, a light, a red green blue lights, a red green blue white lights, a electronic device able to have electronic information relating to invention stored on electronic device and displayed on a electronic device later.

siphon actuated shower have means to adjust temperature This can be any any device including and not limited to, a gate valve, a ball valve, a globe valve, a thermometer, a flow indicator, a control valve, a timer, camera. A microphone, a light, a red green blue lights, a red green blue white lights, a electronic device able to have electronic information relating to invention stored on electronic device and displayed on a electronic device later.

siphon actuated shower of claim 1 further including said siphon actuated shower have means to adjust volume. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

siphon actuated have means to adjust location. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

siphon actuated have means to adjust time. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

siphon actuated shower have means to adjust repetitions. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

siphon actuated shower have means to adjust pressure. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

siphon actuated shower have means to adjust ambient temperature. This can be any device including and not limited to, a gate valve, a ball valve, a globe valve, a thermometer, a flow indicator, a control valve, a timer, a camera. a microphone, a light, a red green blue lights, a red green blue white lights, a electronic device able to have electronic information relating to invention stored on electronic device and displayed on a electronic device later. a electronic device able to have electronic information relating to invention stored on electronic device and means to digitally adjust invention including and not limited to; used to actuate a control valve, activate a light, close a control valve, turn off a light record a temperature, record a flow rate, record a medical information, record a heart rate, record a 02 level, record calories burned.

18. The siphon actuated shower of claim 1 can produce a indicium of sound visual pattern or other mark. Invention can to constructed to make a sound as water and or air move thru method. Can serve as a auditory indicator of invention cycle, actuation or dump of siphon. A light or other means can be constructed to do same.

A first advantage of method is to provide improved condition of start point. A person can stand near within method turn water on and wait, they have time to prepare, do some yoga breathing, some stretching, relax while method fills up with water. No mental psych required. Since method can be located in their residence giving many opportunities to start method. An object of method is it offers an improved condition of start point with a less abrasive even pleasant experience at beginning of session and convenience of location around a person

A second advantage of method is to produce an improved condition of temperature. If method is connected to a shower valve, bathtub or other temperature-controlled water supply then Person can set temperature, or use device to change temperature for person. If method is connected to cold water supply temperature can still be controlled as water fill reservoir it can absorb heat of surroundings so with low flow a person can control a higher temperature. Object of method is it accomplishes an improved condition relating to temperature in form of temperature control and indirectly in form of flow control.

A third advantage to method is to provide an improved condition of volume of therapy medium. This can be accomplished by changing the volume of Reservoir, the Volume of siphon. Also method can improve condition by changing a person perception of volume of therapy medium, method is aesthetically pleasing can produce a soothing sound of water filling reservoir, offers a pleasant presence so a person can not be scared. An Object of method is it provides an improved condition relating to volume of therapy medium in the form of volume of therapy medium adjustment and a pleasant appearance or presence

A fourth advantage to method is to provide an improved condition location of medium contact.

This advantage can be provided by method by a user directing as many siphon outlets person want to anywhere they want. If a user wants multiple siphon outlets they can choose a random siphon pattern or a sequential siphon pattern.

A fifth advantage to method is to provide an improved condition Time of therapy. This advantage can be provided by method by allowing a person to start therapy any time they want and to stop therapy any time they want. There is no start up time of method and no shutdown time. Just turn it on and turn it off. Components of method allow a person to have an enjoyable experience during thermo therapy especially in beginner settings and person can revert back to beginner settings as often as needed Can invest as much time toward thermo therapy as wanted

An Object of method is it provides an improved condition relating to time of therapy in the form of being easy to start and easy to stop. Method is designed to be enjoyable thermo therapy experience especially at beginner levels and a person can revert back to this repeatedly as needed. Method can be located in convenient location adding to availability of time doing therapy

A sixth advantage to method is to provide an improved condition Repetitions of therapy. This advantage can be provided by method by allowing a person to start therapy any time they want and to stop therapy any time they want. There can be no start up time of method and no shutdown time. Just turn it on and turn it off. Components of method allow a person to have an enjoyable experience during thermo therapy especially in beginner settings and person can revert back to beginner settings as often as needed. Can preform as many repetitions of siphon cycles as wanted

An Object of method is it provides an improved condition relating to repetitions of therapy in the form of being easy to start and easy to stop. Method is designed to be enjoyable thermo therapy experience especially at beginner levels and a person can revert back to this repeatedly as needed. Method can be located in convenient location adding to availability of repetitions of therapy

A seventh advantage to method is to provide an improved condition Pressure of medium.

The pressure of medium from siphon outlet can be changed as wanted. An Object of method is it provides an improved condition relating to the pressure of medium as the pressure from medium from siphon outlet can be changed.

Additional advantage of method is it can offer multi use of a shower curtain rod or other useful device.

Additional advantage of method is it can offer a monitor results of conditions dimensions of method for use by medical persons or other applicable entities.

Additional advance of method are it may be used for pre vaccine preparation or post vaccine recovery to work with symptoms.side effects of vaccine.

Drawing Figures

### REFERENCE NUMERALS

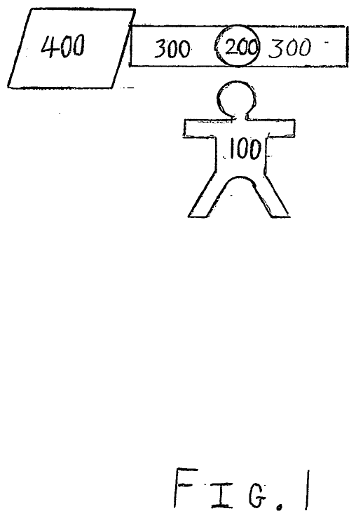

### Description of Method FIG. 1 Preferred Embodiment

A preferred embodiment of Siphon Drive Shower 1000 can be described in FIG. 1. Comprising a Person 100, a Siphon 200, a Reservoir 300, and a Medium Supply 400 which can contribute to method in any manner which make method useful. Including using a siphon device to transfer a medium to the person thru the reservoir and Including but not limited to the improved conditions of thermo therapy; start point, temperature of medium, volume of medium, time of therapy, repetitions of therapy, and pressure of medium.

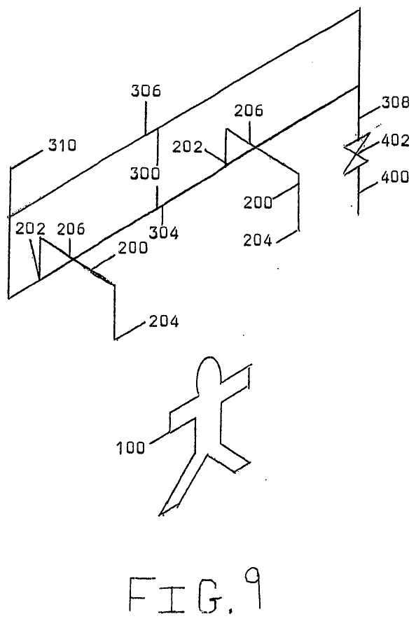

### FIGS. 1-14—Additional Embodiments

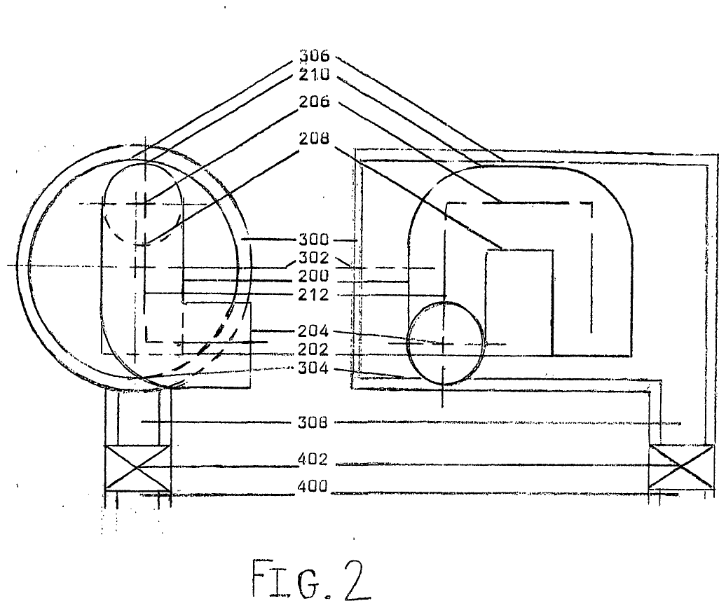

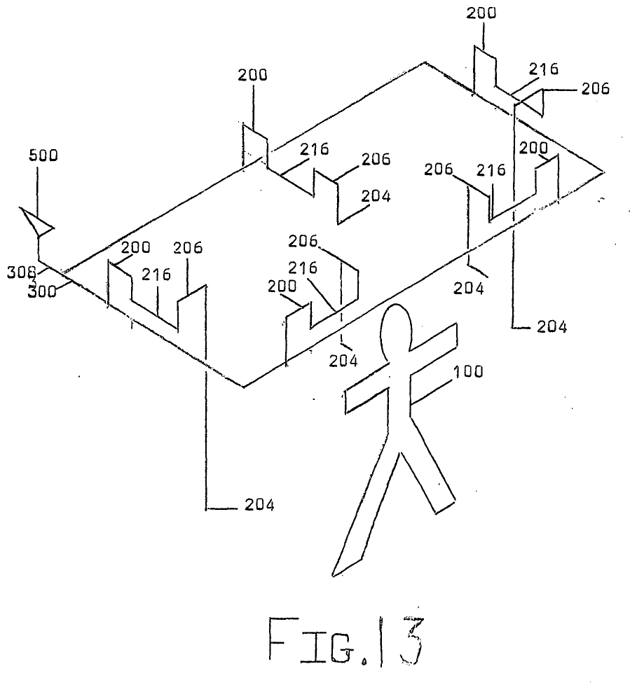

FIG. 1 shows a overview of method including a Person 100, a Siphon 200, a Reservoir 300, and a Medium Supply 400. Any device that makes method useful can be used. Present application can include some examples. As there can be four main components of present method application will describe the procedures each component can contribute and describe the expected static physical structure expected from components. Combinations of components from example drawing figures can be described, however drawings are nonspecific embodiment scope. For example The Medium Supply 400 from FIG. 2 could be used with the Reservoir 300, Siphon 200 and Person 100 from FIG. 13. Any component from a given example can likely be used swapped within other examples components of method. It is the intent of present application to define method as any combination of parts that make it work even if parts aren't in drawings or are in drawings but not numbered.

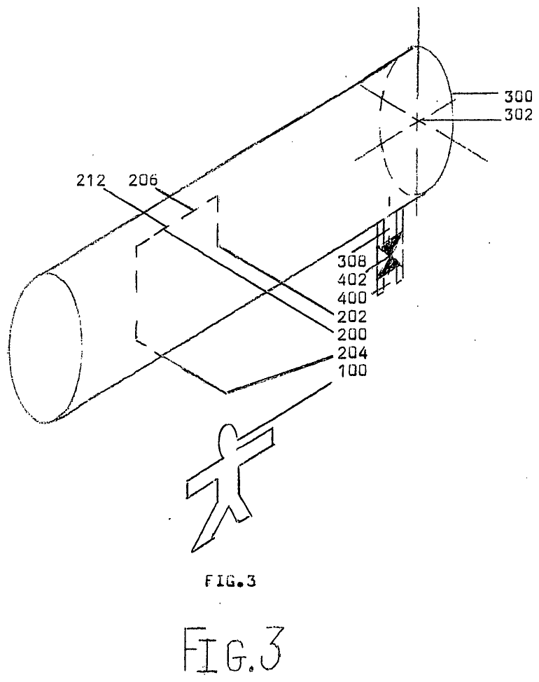

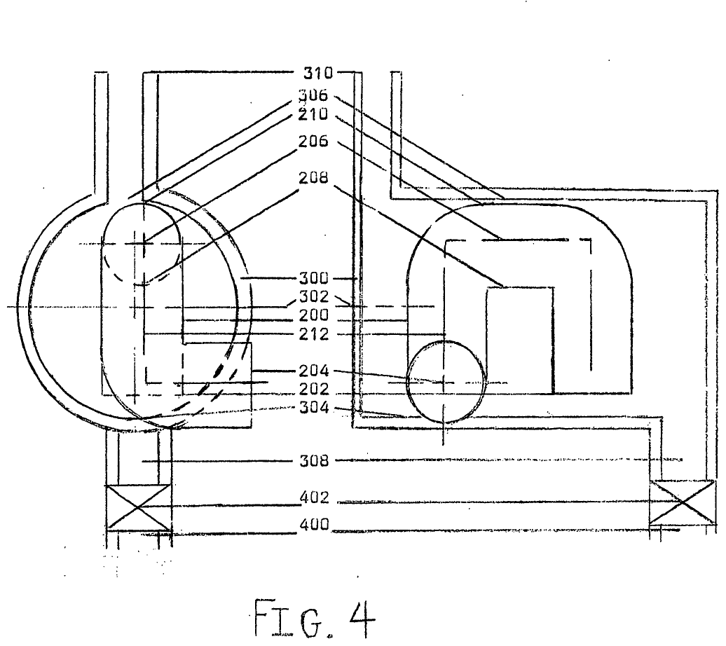

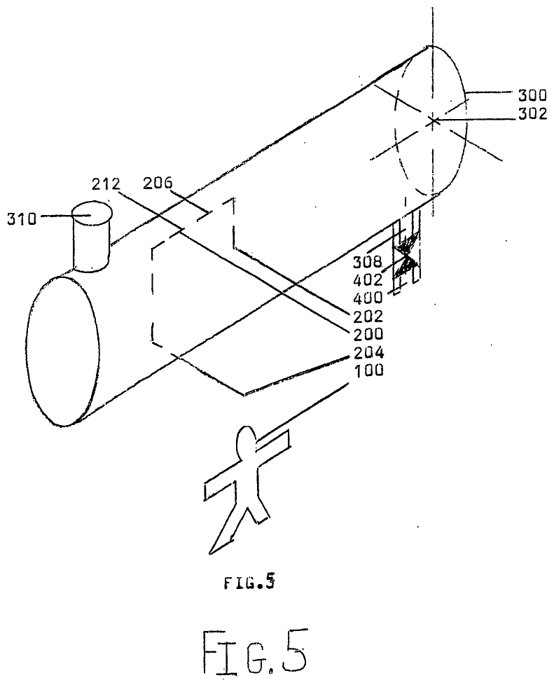

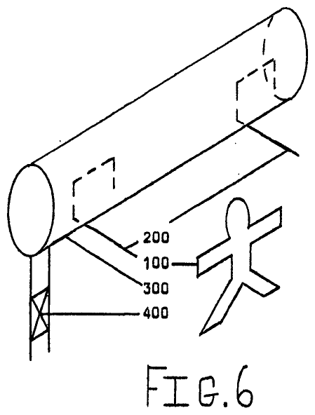

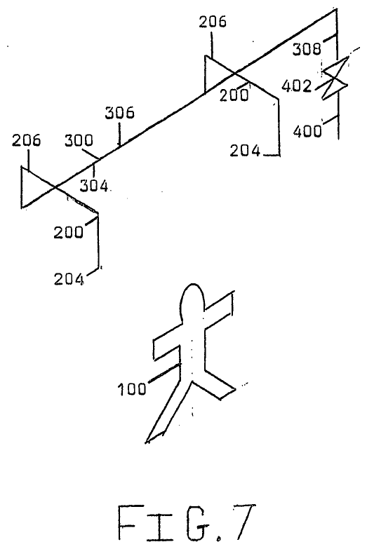

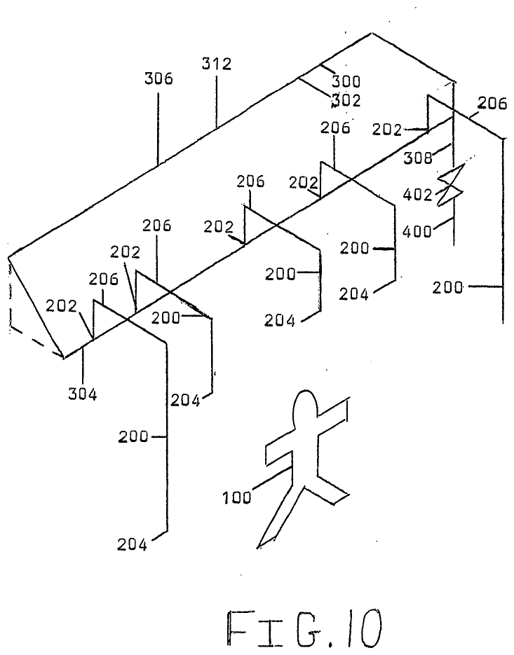

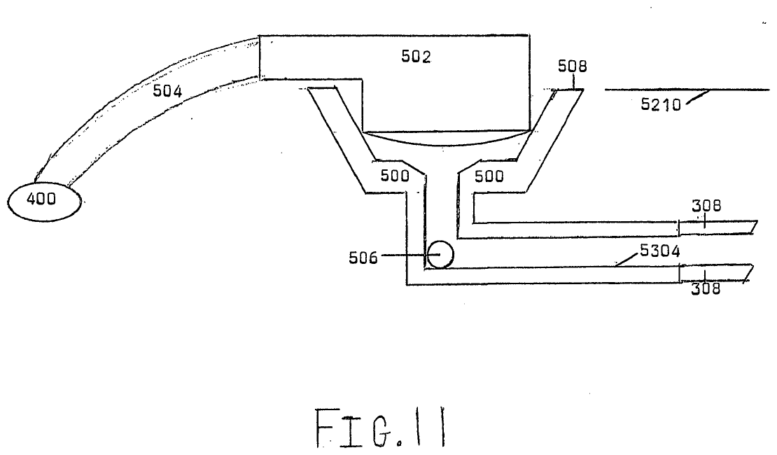

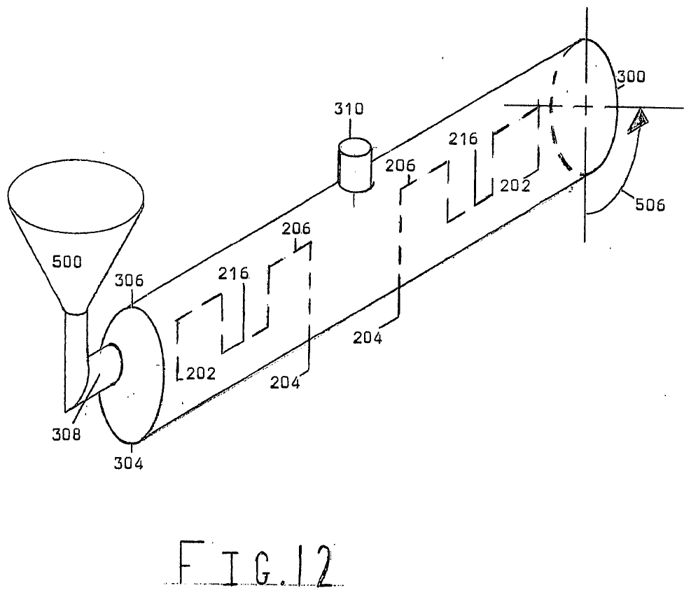

The Medium Supply 400 can be a connection to water supply within a plumbing system of a building, structure. FIGS. 2, 3, 4, 5, 6, 7, 8, 9, and 10 show a Medium Supply 400 which can be a connection to cold water, hot water, or a combination or hot and cold water, method can combine cold water with ambient air or warm water with cold ambient air. Additionally a Medium Valve 402 is shown in FIGS. 2, 3, 4, 5, 7, 8, 9, and 10 this can be a ball valve a gate valve, a globe valve a control valve any other device or method that makes present method work can be used. FIGS. 11, 12, 13 and 14 show a different Medium Supply 400 with a Fill Port 500. This may be useful especially with a shower sprayer. The Siphon 200 is shown in all 14 figures except 11. They are in several different configurations. FIGS. 2, 3, 4, 5, 6, and 12 show Siphon 200 inside a reservoir 300, reservoir 300 could be a larger pipe. FIGS. 3, 5, 6, and 12 show siphon 200 coming off bottom of reservoir 300. FIGS. 2 and 4 show siphon 200 coming off side wall of reservoir 300. Positioning Siphon 200 inside Reservoir may allow for a Shower curtain 600 or other flexible barrier 602 to slide over reservoir. FIGS. 7, 8, 9, 10, and 14 show a Siphon 200 coming off a top of reservoir. The siphon can be any siphon 200 that makes method work, can be used in method. FIG. 3 shows a siphon 200 inside reservoir 300, if an additional siphon 200 is added like on FIG. 6 then one siphon 200 can vent thru for other siphon 200 during cycling or a reservoir vent 310 can be added such as FIG. 5. FIG. 12 and FIG. 13 show a Siphon Dip 216 which can maintain some liquid in between siphon inlet 202 and siphon outlet 204. When another siphon 200 cycles this liquid can remain and then get a head start as all the siphons receive water with next repetition. Allowing for a sequential siphon pattern where the siphons can cycle in a pattern. Siphon apex 206 siphon weir 208 siphon crown 210 could have height adjusted in relation to reservoir bottom 304 therefore changing height as the reservoir fill that the siphon cycle sending water toward user to. Allowing for multiple siphon 200 to be adjusted to cycle at same point producing a random siphon pattern where the siphon that cycle is left to chance, waves or slugs moving across liquid as it fill reservoir, pressure variations moving generally side to side across liquid as it fill the reservoir. Consideration can be given to drainage of siphon when not in use as FIG. 11 shows a means to drain 506. Liquid can be removed from siphon assembly with a turning motion such as FIG. 12 arrow indicates angular rotation of assembly positioning so a turn could drain. A air chamber 312 could be added such as in FIG. 10 as the reservoir fill with water air chamber can trap air which will get compressed in the air chamber in the reservoir this relates to siphon as this compressed air in some configurations can cycle thru siphon 200 when siphon cycle. Additionally any other device that makes siphon work is meant to be part of scope of patent, possibly a flushometer intermittent flush setup or a bellows inside reservoir. Anything that can receive water over a time then dump it on user.

The reservoir 300 can be a pipe with siphon extending off it such as FIGS. 7, 8, 9, 10, 13 and 14.

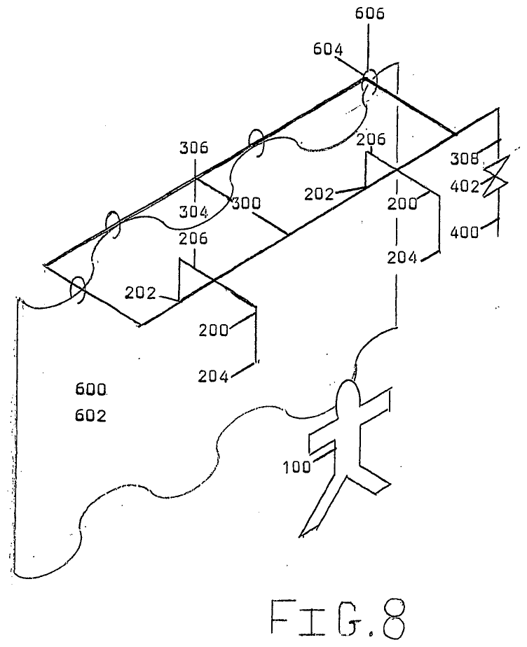

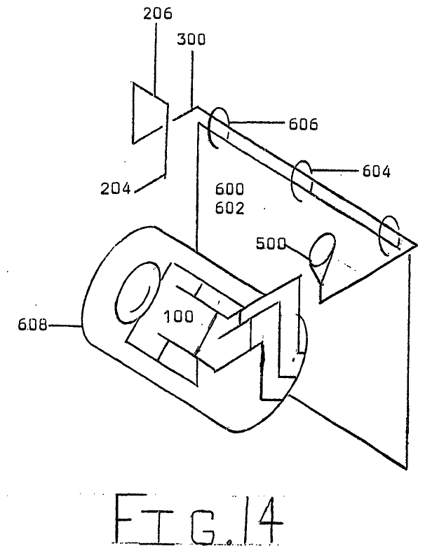

It can be large enough to fit siphon inside such as FIGS. 2, 3, 4, 5, 6, and 12. It could be a dedicated reservoir tank not in figures. It can have a section that has no obstructions extending out from it to allow a shower curtain 600 or flexible barrier 602 to slide unobstructed across it such as FIGS. 8 and 14. Reservoir 300 can be constructed in that as water fill reservoir 300 thru reservoir supply 308 and from reservoir bottom 304 towards reservoir top 306 it may not raise water level flat. It is possible, likely, water level will experience waves or slugs, moving changes in height of water level across filling reservoir 300. This can be expected from movement of water, from changes in direction of water, the displaced air within reservoir 300, movement of reservoir 300 itself. Of course the reservoir can be attached to wall, floor or other means to secure. Any device or method that work as a Reservoir 300 in present method is claimed as the method scope.

The Person 100 can be anyone who wants the benefits of therapy with a thermodynamic medium. Anyone who wants benefit of siphon drive shower 1000. Of course a medical safety step can be recommended before anyone begin a therapy program. A person 100 interested could talk to your doctor first. Person 100 doesn't need to be a fitness extremist as method allows for any degree of temperature tolerance and can be used for relaxation, meditation, rehabilitation and or therapeutic goals. Person 100 could be a dog or cat or other animal. A person 100 may be a group. More than one person 100 can use more than one method at the same time.

An appurtenance can be added to the siphon drive shower for any reason the person want including and not limited to, a temperature of thermo therapy liquid indicator, a flow indicator or pressure indicator, a blood oxygen meter, a heartrate monitor, a blood pressure indicator, a thermometer. A digital thermometer, a handle, a bar, a seat, a physical therapy equipment, a yoga mat, a bathtub, a shower, a hot tub, a sauna, a app for electronic device, any other useful device.

I claim:

1. A siphon curtain rod, comprising:
a. a connection to a shower head water supply pipe,
b. a siphon,
c. a rod reservoir
d. a user, and
e. a drain
whereby said showerhead water supply pipe, can fill said rod reservoir with said water until it dumps thru said siphon in relation to said user the water can enter said drain, providing useful experience

2. The siphon curtain rod of claim 1 further including said siphon curtain rod can operate in conjunction with shower curtain hooks.

3. A siphon actuated shower, comprising:
a. a water source,
b. a siphon,
c. a reservoir,
d. a drain, and
e. a user
whereby said water source can fill said reservoir said water source can fill said siphon said siphon can actuate the water filled from said water source towards a location allowing said user to position in relation to said siphon said drain can redirect the water said user can benefit from said siphon actuated shower in any way found useful.

4. The water source of claim 1 wherein said water source can be an existing plumbing fixture water supply.

5. The water source of claim 1 further including said water source can be a purpose built water supply.

6. The reservoir of claim 1 further including said reservoir can be constructed with means to be purpose built.

7. The drain of claim 1 wherein said drain can be an existing plumbing fixture drain.

8. The drain of claim 1 further including said drain can be constructed with means to be purpose built plumbing fixture drain.

9. The drain of claim 1 further including said drain can have a device to measure.

10. The siphon actuated shower of claim 1 further including said siphon actuated shower can have means to adjust start point.

11. The siphon actuated shower of claim 1 further including said siphon actuated shower have means to adjust temperature.

12. The siphon actuated shower of claim 1 further including said siphon actuated shower have means to adjust volume.

13. The siphon actuated shower of claim 1 further including said siphon actuated shower have means to adjust location.

14. The siphon actuated shower of claim 1 further including said siphon actuated shower have means to adjust time.

15. The siphon actuated shower of claim 1 further including said siphon actuated shower have means to adjust repetitions.

16. The siphon actuated shower of claim 1 further including said siphon actuated shower have means to adjust pressure.

17. The siphon actuated shower of claim 1 further including said siphon actuated shower have means to adjust ambient temperature

18. The siphon actuated shower of claim 1 can produce a indicium of sound visual pattern or other mark.

19. A method for siphonic cycle thermo therapy device, comprising the steps of:
a. providing a medium source of water, and
b. providing a siphon, and
c. providing a reservoir, and
d. providing a drain, and
e. providing a patient, and
f. interconnecting said medium source of water said siphon said reservoir said drain said user with means to said cycle
whereby said medium source of water can energize said reservoir said medium source of water can energize said siphon said medium source of water can the cycle thru said siphon towards a location allowing said user to position juxtapose to said siphon in any way found useful said drain can process medium water.

20. The medium source of water of claim 21 further including said medium source of water can include medicinal additives.

21. The useful of claim 13 further including said useful can be a immune system booster, a vaccine booster, a therapeutic modality, a weight management modality, a exercise modality.

22. The useful of claim 13 further including said any way useful can be a manual operation program.

23. The useful of claim 13 further including said useful can be a software device capable of recording processing electronic information related to said method.
